(19) United States
(12) Patent Application Publication
(10) Pub. No.: US 2019/0278551 A1
(43) Pub. Date: Sep. 12, 2019

(54) VARIABLE LAYOUT MODULE

(71) Applicant: Silicon Video Systems, Inc., Chupei City (TW)

(72) Inventor: Kuei-Hsiang Hsu, Chupei City (TW)

(21) Appl. No.: 15/912,996

(22) Filed: Mar. 6, 2018

(51) Int. Cl. G06F 3/14

(52) U.S. Cl. CPC G06F 3/1446; G09G 2300/026

(57) ABSTRACT

A variable layout module applied to a video wall having a canvas includes a first layout unit, a second layout unit, a third layout unit and an image processing unit. The first layout unit includes multiple first display modules; the second layout unit includes multiple second display modules; the third layout unit includes multiple third display modules; and the image processing unit analyzes each of original resolutions of multiple external image sources, selects at least one of the first resolution, the second resolution and the third resolution according to each of the original resolutions and a permuted and combined resolution, and correspondingly outputs the image sources to the first layout unit, the second layout unit and the third layout unit to display the image sources on the canvas.

### BACKGROUND OF THE INVENTION

### 1. Field of the Invention

The invention relates to a technical field of a video wall, and more particularly to a variable layout module applied to a video wall having a canvas.

### 2. Description of the Prior Art

A conventional video wall has a minimum unit of 2×2 because of the 2×2 incoming contents of input source.

When an input source has the resolution of 3,840×2,160, for example, the resolution needs to be cut into 4 contents of 1,920×1,080 because of the restriction of the output source. The dimension of the video wall needs to be extended in the manner of 2×2, thereby restricting the development of the video wall and the provision of the input source.

In view of this, the invention provides a variable layout module to solve the drawback of the prior art.

### SUMMARY OF THE INVENTION

A first objective of the invention is to provide a variable layout module having layout units that can be flexibly assembled and configured to provide applications to different environments.

According to the above-mentioned variable layout module, a second objective of the invention is to provide a video wall application applicable to an odd number or even number of layout units.

According to the above-mentioned variable layout module, a third objective of the invention is to configure the layout units to move the image between the layout units and an application scenario of a user.

According to the above-mentioned variable layout module, a fourth objective of the invention is to utilize an image processing unit to analyze each of original resolutions of multiple external image sources, to select at least one of a first resolution, a second resolution and a third resolution according to each of the original resolutions and a permuted and combined resolution, and to correspondingly output the image sources to a first layout unit, a second layout unit and a third layout unit.

To achieve the above-identified objects, the invention provides a variable layout module applied to a video wall having a canvas. The variable layout module includes a first layout unit, a second layout unit, a third layout unit and an image processing unit. The first layout unit has multiple first display modules. Each of the first display modules has a first resolution. The second layout unit has multiple second display modules.

Each of the second display modules has a second resolution. The third layout unit has multiple third display modules. Each of the third display modules has a third resolution. The image processing unit is connected to the first layout unit, the second layout unit and the third layout unit. The image processing unit analyzes each of original resolutions of multiple external image sources, selects at least one of the first resolution, the second resolution and the third resolution according to each of the original resolutions and a permuted and combined resolution, and correspondingly outputs the image sources to the first layout unit, the second layout unit and the third layout unit. The first display module, the second display module and the third display module are combined to form the canvas. The image processing unit displays the image source on the canvas.

Compared with the prior art, the invention provides the variable layout module providing various resolutions of layout units, and can provide the resilient combination according to the used environment to form the large-size canvas. Furthermore, the image processing unit of the invention selects the layout unit with the suitable resolution according to the resolutions and the permuted and combined resolution of the external image sources to keep the resolution of the image source, and thus to avoid the image source distortion or the lost of the pixel information of the image source upon reproducing the image source.

### BRIEF DESCRIPTION OF THE DRAWINGS

FIG. 1 is a schematic block diagram showing a variable layout module of an embodiment of the invention.

FIG. 2 is a schematic view showing a first configuration of a first layout unit, a second layout unit and a third layout unit of the invention in FIG. 1.

FIG. 3 is a schematic view showing a second configuration of the first layout unit, the second layout unit and the third layout unit of the invention in FIG. 1.

### DETAILED DESCRIPTION OF THE PREFERRED EMBODIMENTS

In order to make the objectives, characteristics and effects of the invention be sufficiently understood, the following specific embodiment will be described in detail with the accompanying drawings.

In this invention, “a” or “an” is used to describe units, elements or assemblies described herein. This is for illustrative purposes only and provides general meaning to the scope of this invention. Thus, unless expressly stated otherwise, such description should be read to include one and at least one, and the singular form also includes the plural form. In this invention, the terms “comprising,” “including,” “having,” “containing,” or any other similar terms are intended to cover a non-exclusive inclusion. For example, an element, structure, article or device containing plural elements is not limited solely to the elements listed herein, but may include other elements not expressly listed but typically inherent to the element, structure, article or device. In addition, unless expressly stated to the contrary, the term “or” refers to the inclusive “or,” but not to the exclusive “or.”

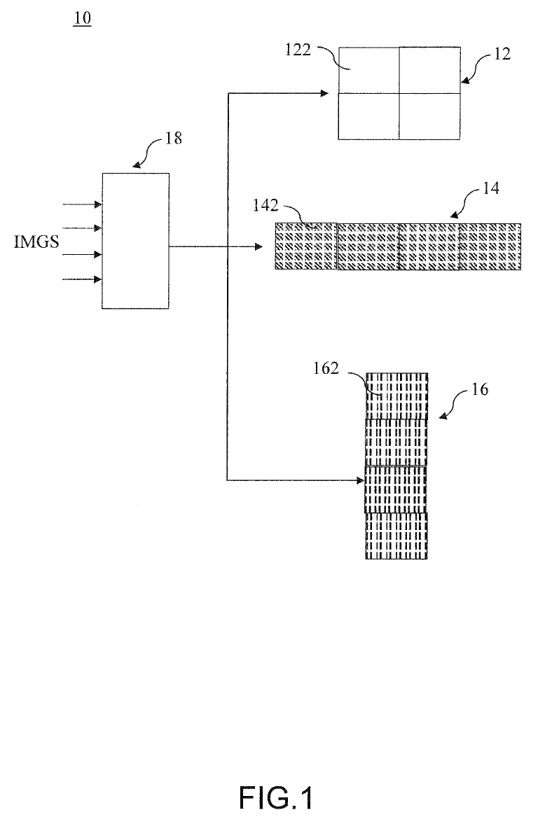

FIG. 1 is a schematic block diagram showing a variable layout module 10 of an embodiment of the invention. Referring to FIG. 1, the variable layout module 10 is applied to a video wall (not shown) having a canvas (not shown).

The variable layout module 10 includes a first layout unit 12, a second layout unit 14, a third layout unit 16 and an image processing unit 18.

The first layout unit 12 includes multiple first display modules 122. For example, the first display module 122 may be a liquid crystal display, a cathode ray tube display, an organic light emitter diode display, a micro light emitting diode display or the like. In this embodiment, the first display module 122 is a 1,920×1,080 liquid crystal display, where the former “1,920” represents the number of pixels in the X-axis direction, and the latter “1,080” represents the number of pixels in the Y-axis direction. The number of the first display modules 122 corresponds to the n×m configuration, where n and m are integers, n is the number of rows, and m is the number of columns. In this embodiment, the numbers of n and m are equal to 2. That is, the first display modules 122 are arranged in a 2×2 array. According to the arrangement, the first display modules 122 construct a first resolution of 3,840×2,160.

The second layout unit 14 includes multiple second display modules 142, wherein the description of the second display module 142 is similar to that for the first layout unit 12, and detailed descriptions thereof will be omitted herein. In this embodiment, the second display module 142 is a 1,920×1,080 liquid crystal display. The number of the second display modules 142 corresponds to the 1×m configuration, where m is an integer. In this embodiment, the number of m is equal to 4. That is, the second display modules 142 are arranged in a 1×4 array. According to the arrangement, the second display modules 142 construct a second resolution of 7,680×1080.

The third layout unit 16 includes multiple third display modules 162, wherein the description of the third display module 162 is similar to that for the first layout unit 12, and detailed descriptions thereof will be omitted herein. In this embodiment, the third display module 162 is a 1,920×1,080 liquid crystal display. The number of the third display modules 162 corresponds to the n×1 configuration, where n is an integer. In this embodiment, the number of n is equal to 4. That is, the third display modules 162 are arranged in a 4×1 array. According to the arrangement, the third display modules 162 construct a third resolution of 1,920×4,320.

The first layout unit 12, the second layout unit 14 and the third layout unit 16 constitute a video wall, wherein the first display modules 122, the second display modules 142 and the third display modules 162 form a canvas.

The image processing unit 18 is connected to the first layout unit 12, the second layout unit 14 and the third layout unit 16. For example, the image processing unit 18 may be a single chip, a microprocessor, a central processing unit or the like. The image processing unit 18 analyzes each of original resolutions of four external image sources IMGS (the number thereof is not restricted to four in other embodiments) according to an algorithm, selects at least one of the first resolution, the second resolution and the third resolution according to each of the original resolutions and and the permuted and combined resolution, and correspondingly outputs the image sources IMGS to the first layout unit 12, the second layout unit 14 and the third layout unit 16.

In another embodiment, each of the original resolutions of the image sources IMGS or the combined resolution of the image sources IMGS may be equal to one of the first resolution, the second resolution and the third resolution.

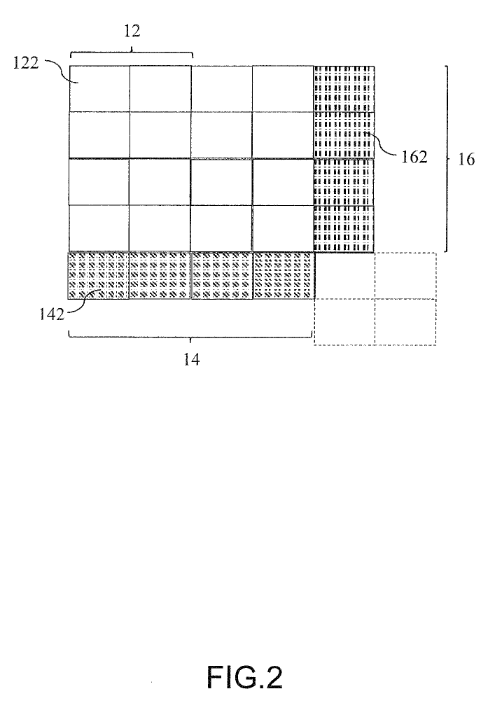

FIG. 2 is a schematic view showing a first configuration of the first layout unit 12, the second layout unit 14 and the third layout unit 16 of the invention in FIG. 1. In FIG. 2, a 5×5 video wall is shown. The video wall may be composed of five sets of the first layout units 12 (2×2), one set of the second layout unit 14 (1×4) and one set of the third layout unit 16 (4×1). According to the configuration method, the first layout unit 12 only has three redundant first display modules 122. Compared with the conventional configuration, the same video wall has 11 redundant display modules.

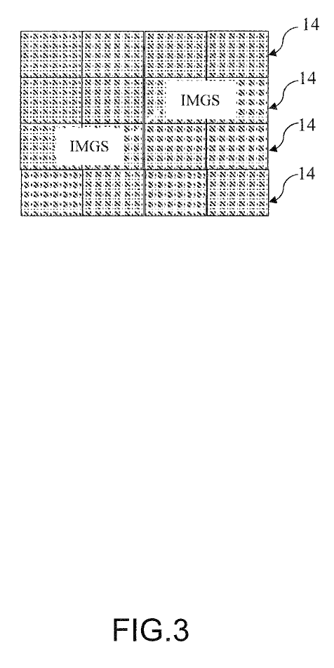

FIG. 3 is a schematic view showing a second configuration of the first layout unit 12, the second layout unit 14 and the third layout unit 16 of the invention in FIG. 1. In FIG. 3, a 4×4 video wall is shown. The video wall may be composed of four sets of the second layout units 14 (1×4) containing, from top to bottom, a first set of the second layout units 14, a second set of the second layout units 14, a third set of the second layout units 14 and a fourth set of the second layout units 14. When the user provides the image source IMGS, which only needs to be moved between the second and third sets of the second layout units 14, the designer can control the image source IMGS through the image processing unit 18 so that the image source IMGS only can be moved between the second and third sets of the second layout units 14 without affecting the first and fourth sets of the second layout units 14, and that the calculation time and loading can be reduced.

The invention has been disclosed hereinabove according to the preferred embodiment. However, it will be understood by those skilled in the art that the embodiment is for illustrative purposes only and should not be read as limiting the scope of this invention. It should be noted that all variations and replacements that are equivalent to this embodiment should be set to cover the scope of this invention. Therefore, the scope of this invention should be defined by the claims.

What is claimed is:

1. A variable layout module applied to a video wall having a canvas, the variable layout module comprising:
a first layout unit having multiple first display modules, wherein each of the first display modules has a first resolution;
a second layout unit having multiple second display modules, wherein each of the second display modules has a second resolution;
a third layout unit having multiple third display modules, wherein each of the third display modules has a third resolution; and
an image processing unit, which is connected to the first layout unit, the second layout unit and the third layout unit, analyzes each of original resolutions of multiple external image sources, selects at least one of the first resolution, the second resolution and the third resolution according to each of the original resolutions and a permuted and combined resolution, and correspondingly outputs the image sources to the first layout unit, the second layout unit and the third layout unit;
wherein the first display modules, the second display modules and the third display modules are combined to form the canvas, and the image processing unit displays the image sources on the canvas.

2. The variable layout module according to claim 1, wherein the number of the first display modules corresponds to an n×m configuration, where n and m are integers.

3. The variable layout module according to claim 1, wherein the number of the second display modules corresponds to a 1×m configuration, where m is an integer.

4. The variable layout module according to claim 1, wherein the number of the third display modules corresponds to an n×1 configuration, where n is an integer.

5. The variable layout module according to claim 1, wherein the number of the image sources is equal to 4.

6. The variable layout module according to claim 1, wherein each of the original resolutions of the image sources and the permuted and combined resolution of the image sources is equal to one of the first resolution, the second resolution and the third resolution.
